(19) United States
(12) Patent Application Publication
(10) Pub. No.: US 2026/0260167 A1
(43) Pub. Date: Sep. 3, 2026

(54) METHODS AND SYSTEMS FOR AUTOMATED MULTI-MODEL SELECTION FOR MEDIA OPTIMIZATION

(71) Applicant: T-Mobile Innovations LLC, Overland Park, KS (US)

(72) Inventors: Aaron McKee, Hastings-on-Hudson, NY (US); Teng FU, Edinburgh (GB)

(21) Appl. No.: 19/554,309

(22) Filed: Mar. 2, 2026

Related U.S. Application Data
(60) Provisional application No. 63/766,338, filed on Mar. 3, 2025.

(51) Int. Cl. G06N 20/00

(52) U.S. Cl. CPC G06N 20/00

(57) ABSTRACT

A method includes training multiple models in parallel based on model training requirements and training data received from one or more external data systems, evaluating candidate models from among the trained data models based on feedback data received from a bidder system to generate performance metrics for the candidate models, and selecting an optimal data model for each line item based on the performance metrics.

### CROSS-REFERENCE TO RELATED APPLICATIONS

This application claims priority to U.S. Provisional Patent Application No. 63/766,338, filed Mar. 3, 2025, titled "METHODS AND SYSTEMS FOR AUTOMATED MULTI-MODEL SELECTION FOR MEDIA OPTIMIZATION," which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In distributed computing environments, resource allocation inefficiencies arise when systems apply uniform processing approaches across heterogeneous datasets with varying characteristics and requirements. Conventional systems that utilize a single processing configuration for diverse input scenarios may experience suboptimal resource utilization, as computing resources are expended on processing operations that are unnecessarily broad or generalized for specific data subsets. This uniform approach results in redundant computational overhead and inefficient memory consumption, as processing systems cannot leverage specialized optimizations tailored to particular data characteristics or operational contexts. Furthermore, manual selection processes for determining appropriate processing configurations introduce latency and scalability limitations that become increasingly pronounced as the volume and diversity of input data grows, leading to degraded system performance and inefficient utilization of available computing resources.

### SUMMARY

In an embodiment, a multi-level model selection system for automated multi-level model training and selection in a bidding environment comprises a configuration application executing at a computer system configured to receive configuration data from a configuration data store and generate model training requirements based on the configuration data, in which the configuration data comprises information identifying targeted data delivery programs and associated targeting parameters, and the model training requirements comprise specifications indicating which hierarchical levels of data models to train and data volume requirements for each hierarchical level. The system further comprises a model trainer application executing at the computer system configured to train a plurality of data models in parallel based on the model training requirements and training data received from one or more external data systems, in which the plurality of data models comprises at least a global model, a country model, and a source model. The system further comprises a model evaluator application executing at the computer system configured to evaluate candidate models from among the trained data models based on feedback data received from a bidder system to generate performance metrics for the candidate models and select an optimal data model for each line item based on the performance metrics. The system further comprises a model metadata application executing at the computer system configured to send model metadata describing the optimal data model to the bidder system to enable the bidder system to automatically identify and load the optimal data model with relevant incoming bid requests.

In another embodiment, a method for automated multi-level model training and selection in a bidding environment comprises receiving, by a configuration application executing at a computer system, configuration data from a configuration data store, in which the configuration data comprises information identifying targeted data delivery programs and associated targeting parameters. The method further comprises generating, by the configuration application, model training requirements based on the configuration data, in which the model training requirements comprise specifications indicating which hierarchical levels of data models to train and data volume requirements for each hierarchical level. The method further comprises training, by a model trainer application executing at the computer system, a plurality of data models in parallel based on the model training requirements and training data received from one or more external data systems, in which the plurality of data models comprises at least a global model, a country model, and a source model. The method further comprises evaluating, by a model evaluator application executing at the computer system, candidate models from among the trained data models based on feedback data received from a bidder system to generate performance metrics for the candidate models. The method further comprises selecting, by the model evaluator application, an optimal data model for each line item based on the performance metrics. The method further comprises sending, by a model metadata application executing at the computer system, model metadata describing the optimal data model to the bidder system to enable the bidder system to automatically identify and load the optimal data model with relevant incoming bid requests.

In yet another embodiment, a non-transitory computer-readable medium stores instructions that, when executed by one or more processors of a computer system, cause the computer system to train a plurality of data models in parallel based on model training requirements and training data received from one or more external data systems, in which the plurality of data models comprises at least a global model, a country model, and a source model. The instructions further cause the computer system to evaluate candidate models from among the trained data models based on feedback data received from a bidder system to generate performance metrics for the candidate models. The instructions further cause the computer system to select an optimal data model for each line item based on the performance metrics.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a multi-level model selection system for automated multi-level model training and selection in a bidding environment according to various embodiments of the disclosure.

FIG. 2 is a block diagram illustrating a method for training multiple data models in parallel in the multi-level model selection system of FIG. 1 according to various embodiments of the disclosure.

FIG. 3 is a block diagram illustrating a method for evaluating candidate models and selecting an optimal data model for each line item in the multi-level model selection system of FIG. 1 according to various embodiments of the disclosure.

FIG. 4 is a flowchart illustrating a first method for automated multi-level model training and selection in a bidding environment according to various embodiments of the present disclosure.

FIG. 5 is a flowchart illustrating a second method for automated multi-level model training and selection in a bidding environment according to various embodiments of the present disclosure.

FIG. 6 is a block diagram of a computer system implemented within the multi-level model selection system of FIG. 1 according to various embodiments of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

In real-time bidding environments, predictive data models may be deployed to evaluate incoming bid requests and generate optimization predictions. A bidding system may process tens of billions of requests daily, each requiring rapid evaluation. Some systems may apply a single uniform data model across all campaigns regardless of campaign characteristics. This uniform approach may create computational inefficiencies. Processing resources may be expended on applying overly broad models where more specialized models could yield superior performance with reduced computational overhead.

When multiple candidate data models exist for potential deployment, determining which model to assign to which campaigns may present technical challenges, such as heavy latency and an extensive use of resource. For example, these processes may not scale effectively across thousands of campaigns having daily model deployment decisions. Systems may lack automated mechanisms for evaluating model performance against actual operational data. Without automated evaluation capabilities, systems may deploy suboptimal models that waste processing resources on low-quality predictions.

Training multiple data models may also consume significant computational resources. Sequential training approaches may introduce delays in model availability. When newly trained models become available, systems may lack efficient mechanisms for distributing model configuration information to downstream bidding systems. Bidding systems may be unable to automatically identify which model to load for incoming requests without manual configuration. This configuration overhead may create deployment bottlenecks. Memory resources may be consumed inefficiently when bidding systems maintain unnecessary models in cache. The lack of automated model selection and metadata distribution mechanisms may result in suboptimal resource utilization and degraded system performance in time-sensitive bidding scenarios.

The present disclosure addresses the aforementioned technical problems in the technical field of automated model training, evaluation, and selection systems for real-time bidding environments by providing a multi-level model selection system that trains multiple data models at different hierarchical levels in parallel, evaluates candidate models from among the trained models using feedback data to generate performance metrics, and automatically selects an optimal data model for each line item based on the performance metrics. By training models (e.g., at global, country, and source hierarchical levels) simultaneously, the system may reduce overall processing time while enabling specialized model deployment tailored to specific targeting parameters. The system may then generate model metadata that enables a bidder system to automatically identify and load the correct trained model for incoming bid requests. This approach may reduce computational overhead associated with applying overly broad models to contexts where specialized models yield superior prediction accuracy with reduced resource consumption.

The multi-level model selection system addresses the aforementioned technical problems through an integrated architecture that automates the model training, evaluation, and selection pipeline. A configuration application executing at the multi-level model selection system receives configuration data from a configuration data store and generates model training requirements based on line item identifiers, optimization type identifiers, country identifiers, and/or source identifiers contained in the configuration data. Each campaign may be represented as a line item. A line item may correspond to an individual campaign with a specific optimization goal and targeting criteria. The line item may be associated with at least one of a source identifier, a country identifier, or an optimization type identifier. The source identifier may correspond to an entity purchasing inventory through a bidder system. The country identifier may indicate a geographic location for targeted data delivery. The optimization type identifier may indicate whether the line item optimizes for clicks, video completions, or pixel page landings. The model training requirements may include specifications indicating which hierarchical levels of data models to train. The specifications may include at least one of a global level, a country level, or a source level. The hierarchical levels may represent different degrees of data aggregation and specialization. The global level may represent the broadest aggregation across all campaigns, the country level may represent geographic specialization, and the source level may represent entity-specific specialization.

In some embodiments, the specifications may also include a line-item level representing the most granular degree of specialization. A line-item-specific model may be trained on data filtered exclusively by line item identifier, in which the line-item-specific model may be trained only on bid requests and events associated with that single line item. Unlike the global model, country model, and source model which function as shared models that can be reused across multiple line items, a line-item-specific model may be a non-shared model dedicated exclusively to a single line item and not deployed to other line items. For example, the line-item-specific model may be trained when the individual line item has accumulated sufficient historical training data to support campaign-specific model training. When sufficient line-item-specific training data exists, the line-item-specific model may provide the highest degree of prediction accuracy tailored to that line item's unique performance characteristics, though training and maintaining line-item-specific models for each line item may require substantially greater computational resources compared to deploying shared models across multiple line items. In some cases, the model training requirements may also include data volume requirements for each hierarchical level. The data volume requirements may specify the amount of historical training data needed to train each model effectively.

The hierarchical data models may be categorized as shared models that are trained once and reused across multiple line items. The global model, country model, and source model may each function as shared models deployed to serve multiple campaigns simultaneously. For example, when the system manages one hundred thousand active line items, rather than training one hundred thousand line-item-specific models, the system may determine that a single shared global model or a limited number of shared country-level models or source-level models achieve sufficient predictive accuracy for most line items. This model sharing approach may provide significant resource efficiency benefits by substantially reducing the total number of models that must be trained and maintained. The system may automatically evaluate whether a shared model trained on broader data aggregations performs comparably to or better than more specialized models for each line item, particularly during cold start periods when newly launched line items lack sufficient historical data for reliable line-item-specific model training. When training data volume for a specific line item falls below predetermined thresholds, more specific models may exhibit reduced predictive accuracy due to overfitting or insufficient statistical significance, whereas broader shared models trained on larger aggregated datasets may demonstrate superior performance despite reduced specificity to individual campaign characteristics.

A model trainer application executing at the multi-level model selection system receives the model training requirements from the configuration application and receives training data from one or more external data systems. The training data may include, for example, bid stream data and/or event data collected over a predetermined time period. The bid stream data may include bid request characteristics and bid response information, in some cases, for won impressions. For example, the bid request characteristics may include attributes such as device type, geographic location, time of day, content category, and user demographics. The bid response information may include whether a bid was placed, the bid amount, and whether the bid won the auction. The event data may include, for example, outcome indicators for delivered targeted content delivery (e.g., showing whether delivered targeted content achieved optimization goals). The training data may be filtered to include only bid requests where the bidder system won the auction, as outcome measurements require delivered targeted content.

The model trainer application may train multiple data models in parallel based on the model training requirements and the training data. The data models may include, for example, at least a global model, a country model, and a source model. The source model may also be referred to herein as an advertiser model. The global model may be trained on aggregated data across all line items. For example, the aggregated data may include bid requests and events from all geographic locations and all sources. The country model may be trained on data filtered by country identifier (e.g., the filtering process may extract only those bid requests and events associated with a specific country code). The source model may be trained on data filtered by source identifier (e.g., filtering process may extract only those bid requests and events associated with a specific entity). The parallel training process may improve resource efficiency by maintaining training data in memory for shared models while applying different filtrations for specialized models, thereby reducing data loading overhead that would otherwise occur in sequential training approaches. Each of the global model, the country model, and the source model may predict a likelihood of an optimization event for incoming bid requests. An optimization event may refer to the occurrence of a desired user action that corresponds to the optimization goal specified for a campaign, such as a user click for click-optimized campaigns, a video completion for video-completion-optimized campaigns, or a pixel page landing for landing-optimized campaigns. For example, the prediction may be expressed as a probability score. By training these models in parallel, the system may reduce overall training time compared to sequential training approaches. Parallel training may involve executing separate training processes simultaneously on different computing resources. The trained data models may be stored in a trained model repository after training is complete.

A model evaluator application executing at the multi-level model selection system accesses the trained data models from the trained model repository. The model evaluator application also receives feedback data from the bidder system. The feedback data may include recent bid request data and corresponding outcome data collected from the bidder system. The feedback data may indicate actual performance of previously deployed data models in real-time bidding scenarios. The feedback data may represent actual operational conditions and results from the bidding environment. The feedback data may provide a basis for evaluating how well each candidate model performs with real-world data. The feedback data may include a sample of recent bid requests processed by the bidder system. For each bid request in the sample, the feedback data may include the actual outcome.

The model evaluator application may evaluate candidate models from among the trained data models based on the feedback data. The evaluation process may involve applying each candidate model to each bid request in the feedback data. For a given line item, the candidate models may include the global model, the country model if available for the line item's country, and the source model if available for the line item's source. The model evaluator application generates performance metrics for the candidate models. The performance metrics may include scores calculated for each of the candidate models. A score may be calculated by applying each candidate model to the feedback data and measuring accuracy of positive event predictions. The scores may measure the proportion of actual positive optimization events that were correctly predicted by the model. For example, if one hundred actual clicks occurred in the feedback data, and a candidate model correctly predicted eighty-five of those clicks as likely to occur, the score for that candidate model may be eighty-five percent. The model evaluator application may calculate scores for each candidate model for each line item.

The model evaluator application may employ a temporal data split methodology to ensure unbiased performance evaluation of the candidate data models. For a line item that has been active for a predetermined period, such as seven days, the system may use historical data from an initial training window, such as the first six days, to train the candidate models while withholding data from a more recent holdout period, such as the most recent day, from the training process. This holdout data may serve as a blind test set against which the system evaluates model performance. By excluding the holdout period data during training, the system may prevent overfitting and may ensure that performance metrics reflect each model's true predictive accuracy on previously unseen data from the same line item. The system may apply each trained candidate model to bid requests from the holdout period to generate predictions, then may compare those predictions against actual outcomes that occurred during the holdout period to calculate accuracy scores. This temporal separation between training data and evaluation data may enable the system to assess how well each model generalizes to new data rather than merely measuring how well it fits historical training data.

The model evaluator application selects an optimal data model for each line item based on the performance metrics. Selecting the optimal data model may include identifying a candidate model with a highest score for each line item. For example, if the global model achieved a score of seventy-five percent, the country model achieved a score of eighty-two percent, and the source model achieved a score of eighty-eight percent for a particular line item, the model evaluator application may select the source model as the optimal data model for that line item. The model evaluator application may update a model selection mapping to indicate which optimal model has been selected for each line item.

The automated selection process may determine whether a shared off-the-shelf model is better than a more specific model for each line item by evaluating competing considerations of model specificity against training data sufficiency. For example, a data source may operate multiple line items simultaneously. For each individual line item, the system may evaluate whether to deploy a line-item-specific model trained exclusively for that line item, a source-specific model that functions as a shared off-the-shelf model deployed across all line items operated by that data source, a country-specific model that functions as a shared off-the-shelf model deployed across all line items within a geographic region, or a global model that functions as a shared off-the-shelf model deployed across all line items in the system. A more specific model, such as a line-item-specific model, may in theory provide superior prediction accuracy by capturing unique performance characteristics specific to that individual line item. However, more specific models may be trained on smaller datasets that may introduce statistical errors due to insufficient training data volume or may exhibit overfitting behaviors when historical data is limited. Conversely, a broader shared off-the-shelf model trained at a higher hierarchical level may sacrifice some degree of predictive specificity to the individual line item's unique characteristics but may demonstrate superior overall performance when trained on larger aggregated datasets that provide greater statistical significance and reduced overfitting risk. The evaluation based on performance metrics calculated from feedback data may enable the system to automatically determine the optimal granularity level for each line item by identifying whether a highly specific model achieves sufficiently accurate predictions to justify its deployment, or whether a broader shared off-the-shelf model provides comparable or superior prediction accuracy despite reduced specialization.

The model selection mapping may be stored in a format that enables rapid lookup operations. For example, when the bidder system processes a bid request associated with a particular line item, the bidder system may query the model selection mapping using the line item identifier to retrieve the optimal model identifier. The model selection mapping may be updated on a periodic basis. In some cases, the model selection mapping may be updated daily after new models are trained and evaluated.

A model metadata application executing at the multi-level model selection system sends model metadata describing the optimal data model to the bidder system. The model metadata may enable the bidder system to automatically identify and load the optimal data model with relevant incoming bid requests. The model metadata may include, for example, a configuration file indicating optimization type identifiers, model filenames, and/or filter rules for the trained data models. The optimization type identifiers may be numerical mappings that correspond to specific optimization goals. For example, clicks may be mapped to identifier one, video completions may be mapped to identifier three, pixel page landings may be mapped to identifier four, etc. The model filenames may specify the exact filename of each trained model file stored in the trained model repository. This specification may enable the bidder system to locate and load the correct model file. The filter rules may be, for example, key-value pairs indicating at least one of a source identifier or a country code for each trained data model. For example, a filter rule may specify that the source model should be used for all bid requests where source identifier equals a specific value. Another filter rule may specify that the country model should be used for all bid requests where country equals a specific country code. The filter rules may be expressed in a structured format such as JSON.

The bidder system may receive the model metadata and parse the model metadata to extract the filter rules. The bidder system may use the filter rules to match characteristics of incoming bid requests to the appropriate trained model. When a bid request is received, the bidder system may extract the source identifier, country identifier, and/or optimization type identifier from the bid request. The bidder system may apply the filter rules specified in the model metadata to identify which trained model to load for evaluating that particular bid request. This automated identification and loading process may significantly reduce latency in the bidding process.

The multi-level model selection system may operate in conjunction with the bidder system and the external data systems to provide continuous model training, evaluation, and deployment capabilities. The configuration data may be received on a periodic basis. The training, evaluating, selecting, and metadata generation processes may be performed on a daily basis. This regular cadence may ensure that models remain current and reflect recent trends in bidding behavior and optimization outcomes.

In some cases, the trained data models and the model selection mapping may be delivered to a bidder cache associated with the bidder system; or the trained data models and the model selection mapping may be stored external to the bidder system (e.g., at the multi-level model selection system) but accessible by the bidder system. The bidder cache may include a memory-based storage system for rapid access during real-time bid evaluation. In either case, when the bidder system receives an incoming bid request, the system may extract the line item identifier from the bid request, and query the model selection mapping using the line item identifier, which may return an optimal model identifier. The bidder system may apply the trained model to the bid request characteristics to generate a prediction regarding the likelihood of an optimization event. The prediction may be expressed as a probability score. Based on this prediction, the bidder system may determine an appropriate bid amount. Alternatively, the bidder system may decide whether to place a bid at all. For example, if the predicted likelihood of a click is below a threshold value, the bidder system may decline to bid. If the predicted likelihood exceeds the threshold, the bidder system may calculate a bid amount proportional to the predicted likelihood.

The system architecture may support scaling to thousands of line items and millions of bid requests per day. The parallel training approach may enable the system to train multiple models simultaneously without sequential bottlenecks. The model trainer application may distribute training tasks across multiple computing nodes in a distributed computing environment. Each computing node may train one or more models independently, or multiple computing nodes may collaborate to train a single model using conventional distributed training techniques. Each computing node may train one or more models independently. The trained models may be collected and stored in the trained model repository upon completion. The automated evaluation and selection process may eliminate the need for manual review of thousands of model performance results. The model evaluator application may process performance metric calculations for all line items programmatically. The automated selection based on highest scores may ensure consistent, objective model assignment decisions. By caching only the selected optimal models in the bidder cache, the system may optimize memory utilization. Instead of caching all candidate models for all line items, the bidder cache may cache only one model per line item. This selective caching approach may reduce memory footprint. The model metadata may also enable the bidder system to identify the correct model without maintaining complex lookup logic.

This technical solution directly addresses the aforementioned technical problems by substantially eliminating computational inefficiencies associated with applying uniform global models to diverse campaigns with varying characteristics. By training models at multiple hierarchical levels, the system may reduce unnecessary processing overhead by deploying specialized models tailored to specific geographic regions or individual sources where sufficient training data exists. The parallel training approach may minimize overall training time by executing multiple training processes simultaneously rather than sequentially. The automated evaluation and selection process may significantly reduce latency introduced by manual model selection procedures and may enable the system to scale effectively across thousands of line items without requiring human intervention for daily deployment decisions. By calculating performance metrics based on feedback data from actual bidding scenarios, the system may ensure that the highest-performing model is selected for each line item, thereby optimizing prediction accuracy. The model metadata generation and distribution mechanism may enable the bidder system to automatically identify and load the correct trained model for each incoming bid request based on filter rules matching request characteristics to model specifications. The hierarchical model approach also provides optimization capability during cold start periods when newly launched line items lack sufficient data for specialized model training, as broader shared models remain available to generate predictions until line-item-specific data volume becomes sufficient. This automated identification process may reduce computational resource consumption by eliminating the need to evaluate multiple models for each bid request. The system may optimize memory utilization by caching only the selected optimal models rather than maintaining all candidate models in memory. By matching model specialization to the specific characteristics of each line item, the system may achieve improved prediction accuracy with reduced processing time per bid request, thereby enhancing overall system throughput and enabling more efficient utilization of available computing resources in the real-time bidding environment.

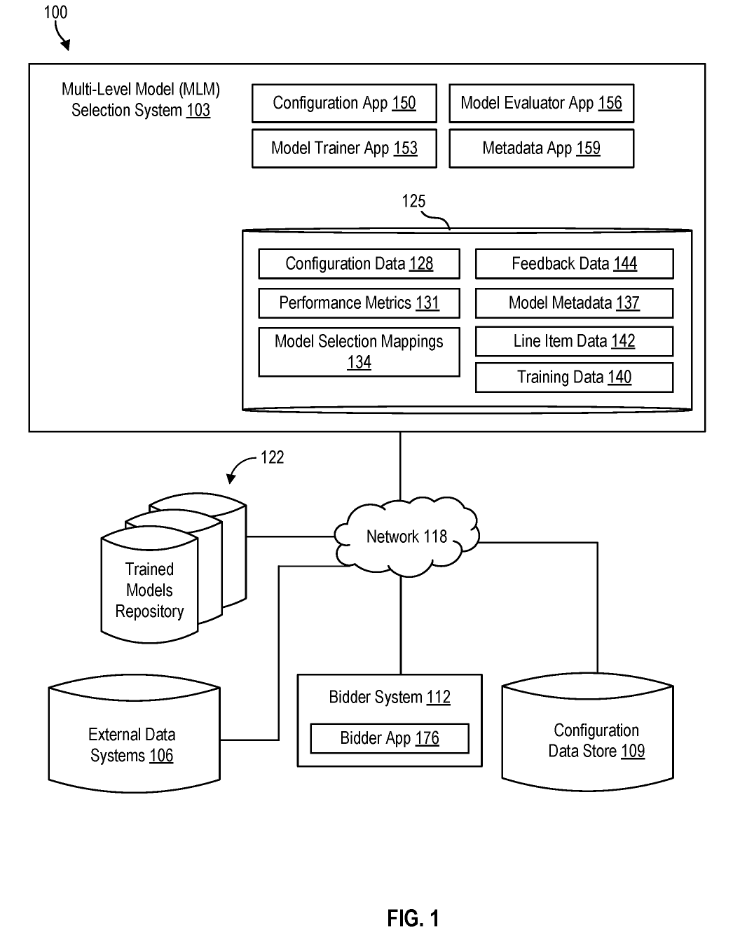

Turning now to FIG. 1, shown is a diagram illustrating a multi-level model selection system 103 for automated multi-level model training and selection in a bidding environment 100 according to various embodiments of the disclosure. The multi-level model selection system 103 may be in communication with a configuration data store 109, one or more external data systems 106, one or more bidder systems 112, and one or more trained model repositories 122 through a network 118. While FIG. 1 illustrates the configuration data store 109, external data systems 106, bidder system 112, and trained model repository 122 as being separate from the multi-level model selection system 103, in some embodiments, it should be appreciated that one or more of these components may be integrated within the multi-level model selection system 103 or may be distributed across multiple computing environments.

The multi-level model selection system 103 may refer to a computing system comprising one or more processors, one or more memories coupled to the one or more processors, and network communication interfaces enabling data exchange with external systems. The multi-level model selection system 103 may be implemented as a server system, a distributed computing cluster, a cloud-based computing environment, or a combination of on-premises and cloud infrastructure. As shown in FIG. 1, the multi-level model selection system 103 includes a configuration application 150, a model trainer application 153, a model evaluator application 156, and a metadata application 159, each of which may be instructions stored in a memory of the multi-level model selection system 103. The multi-level model selection system 103 also includes a data store 125 for storing the configuration data 128, performance metrics 131, model selection mappings 134, feedback data 144, model metadata 137, line item data 142, and training data 140.

The configuration data 128 may refer to structured data defining active campaigns represented as line items, in which each line item may include a unique line item identifier, a source identifier, a country identifier, an optimization type identifier, and targeting parameters. The configuration data 128 may be received from the configuration data store 109 and may be updated periodically to reflect changes in campaign specifications. The performance metrics 131 may refer to quantitative measures of model performance calculated by the model evaluator application 156, in which the performance metrics 131 may include scores indicating the proportion of actual positive optimization events correctly predicted by each candidate model for each line item. The performance metrics 131 may be organized as records associating model identifiers with scores and line item identifiers to enable comparison of different models for the same line item.

The model selection mappings 134 may refer to data structures storing associations between line item identifiers and optimal model identifiers selected based on the performance metrics 131. Each record may include a line item identifier, an optimal model identifier specifying which trained model file should be used, and a model type indicator showing whether the selected model is a global model, country model, or source model. The feedback data 144 may refer to recent operational data received from the bidder systems 112 comprising bid request samples and corresponding actual outcomes. The feedback data 144 may include bid request characteristics and binary outcome indicators showing whether optimization events occurred. The model metadata 137 may refer to configuration information describing optimal model selections and enabling automated model identification by the bidder systems 112. The model metadata 137 may include optimization type identifiers, model filenames, and filter rules comprising key-value pairs that match bid request characteristics to appropriate models. The line item data 142 may refer to detailed campaign information associated with each line item. The line item data 142 may include campaign dates, budget allocation, pacing information, creative specifications, and historical performance data. The training data 140 may refer to historical bidding and event data received from the external data systems 106 and used to train the plurality of data models. The training data 140 may include bid stream data including bid request characteristics and bid response information, and event data comprising outcome indicators showing whether delivered targeted content achieved optimization goals.

The configuration application 150 may refer to a software application executing at the multi-level model selection system 103 that receives configuration data 128 from the configuration data store 109 and analyzes the configuration data 128 to generate model training requirements. The configuration application 150 may be configured to identify which line items are currently active by examining campaign dates. The configuration application 150 may determine which hierarchical levels of models to train by analyzing data volume thresholds. The configuration application 150 may generate model training requirements that include specifications indicating which hierarchical levels to train, such as global, country, and source levels, along with data volume requirements specifying how much historical training data should be retrieved for each model. The configuration application 150 may transmit the model training requirements to the model trainer application 153.

The model trainer application 153 may refer to a software application executing at the multi-level model selection system 103 that receives model training requirements from the configuration application 150 and training data 140 from the one or more external data systems 106. The model trainer application 153 may be configured to train a plurality of data models in parallel based on the model training requirements and the training data 140. The trained data models may include at least a global model trained on aggregated data across all line items, a country model trained on geographically filtered data, and a source model trained on entity-specific filtered data. Each trained model may be a machine learning model configured to predict the likelihood of an optimization event occurring given input features derived from bid request characteristics. The model trainer application 153 may store the trained data models in the trained model repository 122 with associated metadata including the hierarchical level, applicable filters, optimization type, and training date.

The model evaluator application 156 may refer to a software application executing at the multi-level model selection system 103 that accesses trained data models from the trained model repository 122 and receives feedback data 144 from the bidder systems 112. The model evaluator application 156 may be configured to evaluate candidate models from among the trained data models by applying each candidate model to each bid request in the feedback data 144 to generate predictions, comparing the predictions against actual outcomes, and calculating performance metrics 131 such as scores for each candidate model for each line item. The score may measure the proportion of actual positive optimization events that were correctly predicted by the model. The model evaluator application 156 may select an optimal data model for each line item based on the performance metrics 131 by identifying the candidate model with the highest score for that line item. The model evaluator application 156 may update model selection mappings 134 to indicate which optimal model has been selected for each line item.

The metadata application 159 may refer to a software application executing at the multi-level model selection system 103 that generates and sends model metadata 137 describing the optimal data model selections to the bidder systems 112. The model metadata 137 may enable the bidder systems 112 to automatically identify and load the optimal data model with relevant incoming bid requests without requiring manual configuration. The model metadata 137 may include a configuration file indicating optimization type identifiers, model filenames specifying the exact filename of each trained model file, and filter rules comprising key-value pairs that enable the bidder systems 112 to match characteristics of incoming bid requests to appropriate trained models. The metadata application 159 may transmit the model metadata 137 to the bidder systems 112 through the network 118, thereby enabling the bidder systems 112 to automatically identify which trained model to load for each incoming bid request based on the request's source identifier, country identifier, and optimization type identifier, eliminating manual model selection procedures and reducing latency in the bidding process.

The external data systems 106 may refer to computing systems that collect and store bid stream data and/or event data from the bidding environment 100. The external data systems 106 may include data collection services that receive bid requests and bid responses from advertising exchanges and supply-side platforms participating in real-time bidding auctions. The external data systems 106 may include event tracking systems that receive event notifications when users interact with delivered targeted content, such as pixel firing events indicating clicks or video completion events from video players. The external data systems 106 may include event data storage that stores outcome indicators for delivered targeted content delivery and processing clusters that aggregate and process the training data 140 before providing the training data 140 to the model trainer application 153. The outcome indicators stored in the event data may refer to binary or categorical values indicating whether specific optimization events occurred, such as a binary flag with a value of 1 for click events and 0 for non-click events. The outcome indicators may be associated with bid request identifiers enabling the external data systems 106 to join bid stream data with event data to create complete training records. The processing clusters may include distributed computing systems that execute data transformation pipelines to clean, filter, aggregate, and format raw bid stream data and event data into training data 140 suitable for model training. The external data systems 106 may expose APIs or database connections that enable the model trainer application 153 to retrieve training data 140 based on specified date ranges, line item identifiers, country identifiers, and source identifiers.

The configuration data store 109 may refer to a database system that maintains current campaign configuration information used by the multi-level model selection system 103 to determine which models to train. The configuration data store 109 may be implemented as a relational database management system, a NoSQL database, or a cloud-based database service. The configuration data store 109 may store configuration data 128 including line item definitions that specify campaign parameters such as line item identifiers, source identifiers, country identifiers, optimization type identifiers, campaign start dates, campaign end dates, and targeting criteria. The configuration data 128 stored in the configuration data store 109 may be populated and maintained by campaign management systems used by entities purchasing inventory through the bidder systems 112, in which campaign managers may create new line items, modify existing line items, and adjust targeting parameters through user interfaces. The configuration application 150 may query the configuration data store 109 on a periodic basis, such as daily, to retrieve current configuration data 128 reflecting all active line items and their associated parameters. The configuration data store 109 may expose query interfaces such as SQL query interfaces or RESTful APIs.

The bidder systems 112 may refer to computing systems that process incoming bid requests in real-time bidding scenarios. As shown in FIG. 1, each bidder system 112 may include a bidder application 176 that receives the model metadata 137 from the metadata application 159 and uses the model metadata 137 to automatically identify and load optimal trained models for evaluating bid requests. The bidder application 176 may refer to software executing at the bidder system 112 that implements core bidding logic including receiving bid requests, extracting bid request characteristics, identifying which line item the bid request is associated with, querying the model selection mappings 134 to determine which trained model to use, loading the identified trained model, applying the trained model to generate a probability score, determining whether to place a bid, and calculating a bid amount. The bidder application 176 may also generate and transmit feedback data 144 to the model evaluator application 156 to enable continuous evaluation of model performance.

The network 118 may refer to communication infrastructure enabling data exchange between the multi-level model selection system 103 and the connected systems. The network 118 may include one or more wide area networks, local area networks, or a combination thereof, utilizing wired or wireless communication protocols.

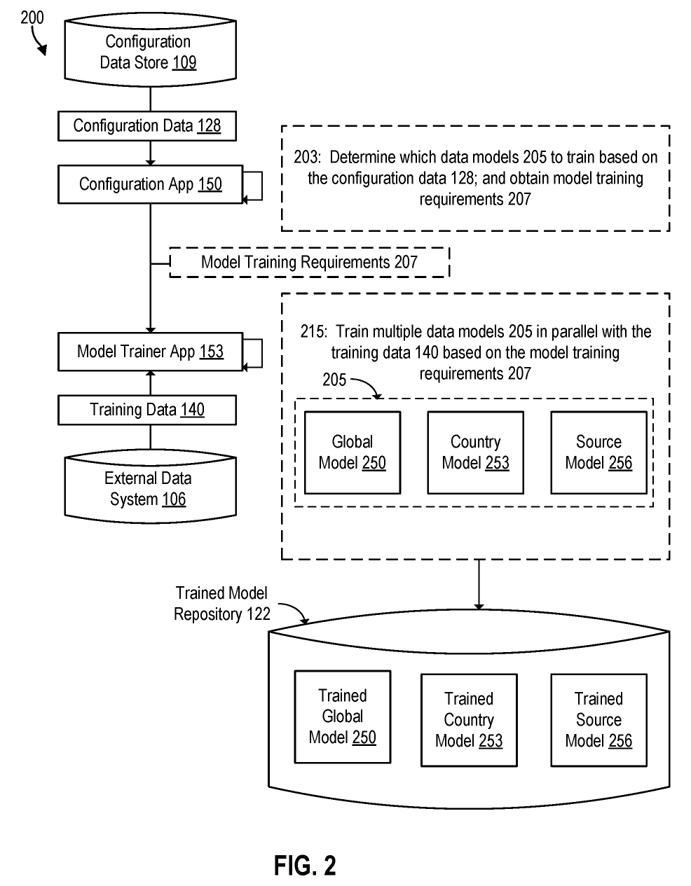

Turning now to FIG. 2, shown is a diagram illustrating a method 200 for training multiple data models 205 in parallel in the multi-level model selection system 103 according to various embodiments of the disclosure. A data model may refer to a machine learning model comprising parameters and computational logic configured to predict the likelihood of an optimization event based on input features derived from bid request characteristics. As used herein, “hierarchical data models” or a “hierarchy of data models" may refer to multiple data models trained at different hierarchical levels, in which each hierarchical level corresponds to a different degree of data aggregation or specialization, such as a global level representing aggregated data across all campaigns, a country level representing geographically filtered data, and a source level representing entity-specific filtered data. As used herein, a "data model file" may refer to a serialized representation of a trained data model stored in a file format such as pickle format, ONNX format, or other machine learning model serialization format. The data model file contains the trained parameters and structure enabling the model to be loaded into memory and executed for inference operations. The multiple data models 205 trained in method 200 may include at least a global model 250 trained at the global hierarchical level, a country model 253 trained at the country hierarchical level, and a source model 256 (also referred to herein as an advertiser model) trained at the source hierarchical level. These data models 205 collectively form a hierarchy of models based on their respective levels of data specialization.

Method 200 may be performed by the configuration application 150 and the model trainer application 153 executing at the multi-level model selection system 103. Method 200 may be executed on a periodic basis, such as daily, to generate fresh trained data models reflecting recent bidding behavior and optimization outcomes.

Method 200 may begin with operation 203. At operation 203, the configuration application 150 may determine which data models 205 to train based on the configuration data 128 received from the configuration data store 109. The configuration application 150 may obtain model training requirements 207 defining the determined data models 205 to train based on the configuration data 128. For example, configuration application 150 may analyze the configuration data 128 to identify active line items and their associated targeting parameters (e.g., source identifiers, country identifiers, and/or optimization type identifiers). The configuration application 150 may determine which hierarchical levels of data models 205 should be trained by evaluating data volume thresholds. For example, the configuration application 150 may determine that a source model should be trained for a particular source identifier only if at least thirty days of historical training data exists for that source. For example, model training requirements 207 may specify which hierarchical levels to train, such as global, country, and source levels, along with data volume requirements indicating how much historical training data should be retrieved for each model. The model training requirements 207 may include a structured data specification that includes, for example, hierarchical level indicators identifying which model types to train (e.g., global, country, source), filter parameters specifying applicable country codes and source identifiers for specialized models, data volume thresholds defining minimum training data requirements for each hierarchical level, time window specifications indicating the date range for training data retrieval, and/or optimization type mappings associating each model with specific optimization goals such as clicks, video completions, or pixel page landings. The model training requirements 207 may be transmitted to the model trainer application 153 to initiate the parallel training process.

At operation 215, the model trainer application 153 may train multiple data models 205 in parallel with the training data 140 based on the model training requirements 207. The model trainer application 153 may receive training data 140 from the external data systems 106, in which the training data 140 comprises bid stream data and event data collected over a predetermined time period. The model trainer application 153 may filter and partition the training data 140 to create separate datasets for each hierarchical level of the data models 205 (e.g., global model 250, country model 253, and source model 256) based on the model training requirements 207. The source model 256 may also be referred to herein as an advertiser model. The global model 250 may be trained on aggregated training data 140 across all line items without filtering. The country model 253 may be trained on training data 140 filtered to include only bid requests and events associated with a specific country code. The source model 256 may be trained on training data 140 filtered to include only bid requests and events associated with a specific source identifier. Each data model 205 may be a machine learning model configured to predict the likelihood of an optimization event occurring based on bid request characteristics. By training these data models 205 in parallel, the model trainer application 153 may reduce overall training time compared to sequential training approaches. The parallel training may involve executing separate training processes simultaneously on different computing resources in a distributed computing environment.

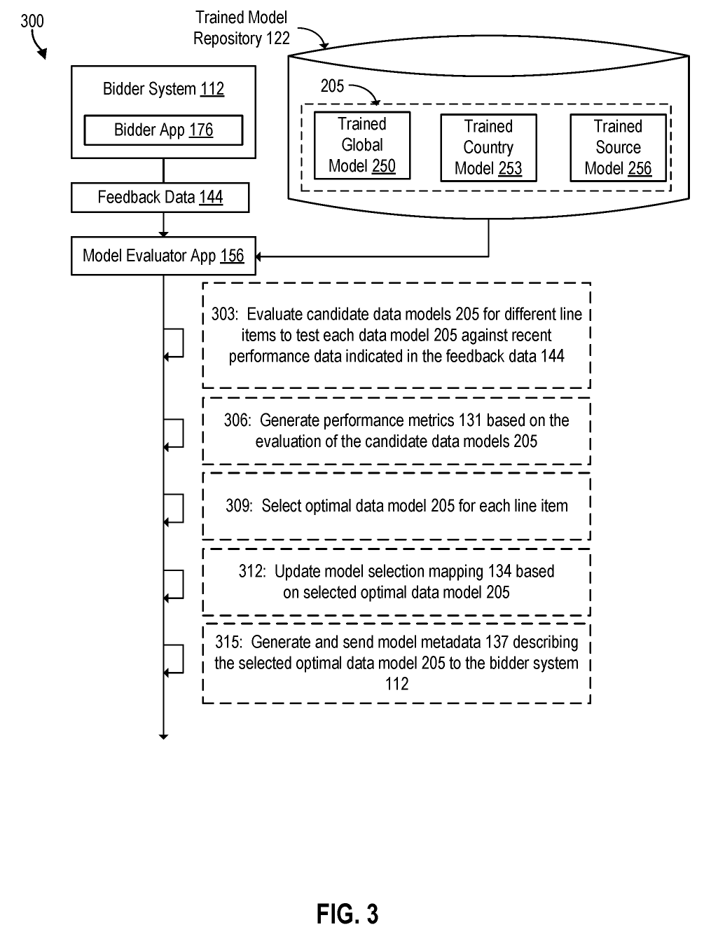

Upon completion of training, the model trainer application 153 may store the trained data models in the trained model repository 122. As shown in FIG. 2, the trained model repository 122 receives the trained global model 250, the trained country model 253, and the trained source model 256. Each trained data model 205 may be stored with associated metadata including the hierarchical level, applicable filters such as country code or source identifier, optimization type, training date, and/or performance characteristics measured during training. The trained data models stored in the trained model repository 122 may subsequently be accessed by the model evaluator application 156 for evaluation and optimal model selection, as further described in FIG. 3.

Turning now to FIG. 3, shown is a diagram illustrating a method 300 for evaluating and selecting optimal data models in the multi-level model selection system 103 according to various embodiments of the disclosure. In particular, method 300 may be performed by the model evaluator application 156 and the metadata application 159 executing at the multi-level model selection system 103. Method 300 may be executed on a periodic basis, such as daily, to evaluate newly trained data models against actual operational data and select optimal models for deployment to the bidder systems 112.

Method 300 may begin with operation 303. At operation 303, the model evaluator application 156 may evaluate candidate data models 205 for different line items to test each data model 205 against recent performance data indicated in the feedback data 144. The model evaluator application 156 may access the trained data models from the trained model repository 122, such as the trained global model 250, the trained country model 253, and the trained source model 256. The model evaluator application 156 may receive feedback data 144 from the bidder system 112, in which the feedback data 144 comprises recent bid request data and corresponding outcome data collected from the bidder application 176. The feedback data 144 may represent a sample of actual bid requests processed by the bidder system 112 over a recent time window, such as the previous twenty-four hours or previous seven days, along with the actual outcomes that occurred for those bid requests, such as whether a user clicked on targeted content, completed viewing video content, or landed on a destination webpage.

For a given line item, the candidate data models 205 may include the global model 250 which is always available, the country model 253 if available for the line item's country based on sufficient training data existing for that country, and the source model 256 if available for the line item's source based on sufficient training data existing for that source. The evaluation process may involve applying each candidate data model 205 to each bid request in the feedback data 144. For example, applying a data model 205 may involve extracting bid request characteristics from the feedback data 144 (e.g., device type, geographic location, time of day, content category, and/or user demographics), transforming those characteristics into numerical feature vectors that serve as input to the data model 205, executing the data model's computational logic to process the feature vectors through the model's learned parameters, and generating a prediction output with a probability score between zero and one indicating the likelihood that an optimization event will occur for that bid request. The model evaluator application 156 may then compare each prediction generated by each candidate data model 205 against the actual outcome recorded in the feedback data 144 for that same bid request to determine whether the prediction was accurate.

At operation 306, the model evaluator application 156 may generate performance metrics 131 based on the evaluation of the candidate data models 205. The performance metrics 131 may be scores calculated for each of the candidate data models 205 for each line item. A score may be calculated by applying each candidate data model 205 to the feedback data 144 and measuring accuracy of positive event predictions. For example, the model evaluator application 156 may classify each prediction as either a true positive, false positive, true negative, or false negative by comparing the predicted probability score against a threshold value such as fifty percent and comparing the classification result against the actual outcome. For example, if a candidate data model 205 generated a probability score of seventy percent for a particular bid request, indicating a prediction that an optimization event would occur, and the feedback data 144 shows that an optimization event actually did occur for that bid request, this may be classified as a true positive prediction. Conversely, if the data model 205 predicted that an optimization event would occur but the feedback data 144 shows that no optimization event actually occurred, this may be classified as a false negative prediction. The score may measure the proportion of actual positive optimization events that were correctly predicted by the data model 205, calculated by dividing the count of true positive predictions by the sum of true positive predictions plus false negative predictions. For example, if one hundred actual clicks occurred in the feedback data 144 for a particular line item, and a candidate data model 205 correctly predicted eighty-five of those clicks as likely to occur by assigning probability scores above the threshold value, while missing fifteen clicks by assigning probability scores below the threshold value, the score for that candidate data model 205 may be eighty-five percent or zero point eight five. The model evaluator application 156 may calculate scores for each candidate data model 205 for each line item, creating a performance data structure (e.g., matrix) that enables comparison of how well the global model 250, country model 253, and source model 256 each performed for each individual line item.

At operation 309, the model evaluator application 156 may select an optimal data model 205 for each line item based on the performance metrics 131. Selecting the optimal data model 205 may involve identifying a candidate data model 205 with a highest score for each line item through a comparison operation that evaluates the scores of all available candidate models for that line item. For example, if the global model 250 achieved a score of seventy-five percent, the country model 253 achieved a score of eighty-two percent, and the source model 256 achieved a score of eighty-eight percent for a particular line item, the model evaluator application 156 may select the source model 256 as the optimal data model 205 for that line item because its eighty-eight percent score exceeds the scores of the alternative candidate models. The selection process may include fallback logic such that if a source model 256 is not available due to insufficient training data for a particular source, the model evaluator application 156 compares the global model 250 against the country model 253 if available, and if no country model 253 is available, the model evaluator application 156 defaults to the global model 250 which is always available for all line items.

At operation 312, the model evaluator application 156 may update model selection mappings 134 based on the selected optimal data model 205. The model selection mappings 134 may store associations between line item identifiers and the corresponding optimal data models 205 selected for those line items. Each record in the model selection mappings 134 may include a line item identifier field containing a unique identifier for the line item, an optimal model identifier field specifying which trained model file should be used for that line item, a model type indicator identifying the selected model, and a score value indicating the performance metric that led to the selection. The model selection mappings 134 may be stored in a format that enables rapid lookup operations by the bidder systems 112 during real-time bidding operations.

At operation 315, the metadata application 159 may generate and send model metadata 137 describing the selected optimal data model 205 to the bidder system 112. The model metadata 137 may enable the bidder system 112 to automatically identify and load the optimal data model 205 with relevant incoming bid requests without requiring manual configuration. The model metadata 137 may comprise a configuration file indicating optimization type identifiers that map optimization goals to numerical identifiers, model filenames specifying the exact filename or file path of each trained model file stored in the trained model repository 122, and/or filter rules comprising key-value pairs that enable the bidder system 112 to match characteristics of incoming bid requests to appropriate trained models based on source identifiers and country codes. The bidder application 176 may receive the model metadata 137 and parse the model metadata 137 to extract the filter rules into an in-memory data structure. The bidder application 176 may use the model metadata 137 to automatically identify which trained data model to load for each incoming bid request based on the request's source identifier, country identifier, and optimization type identifier.

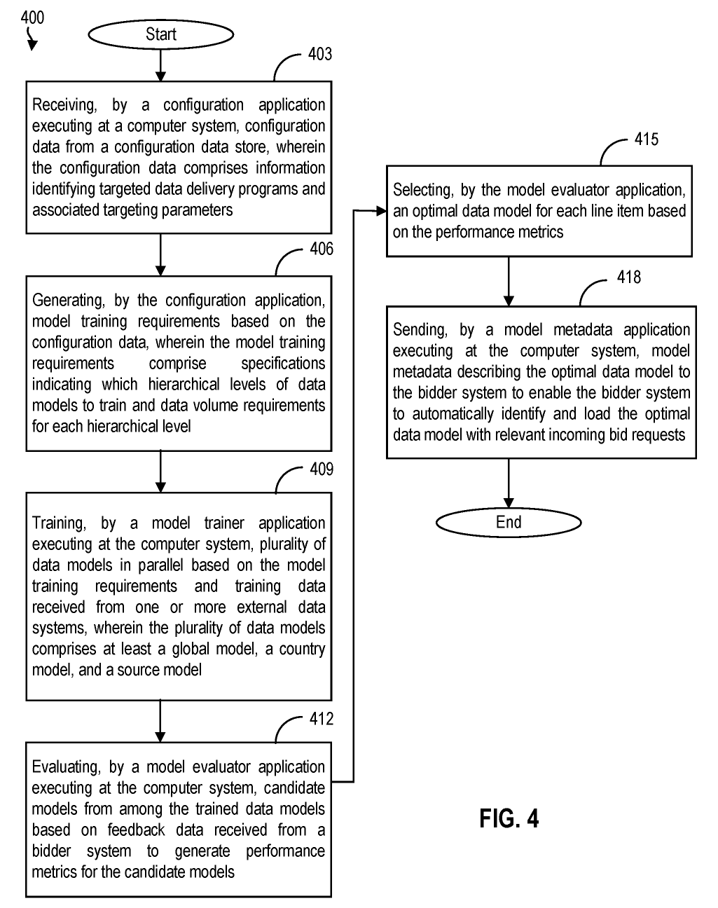

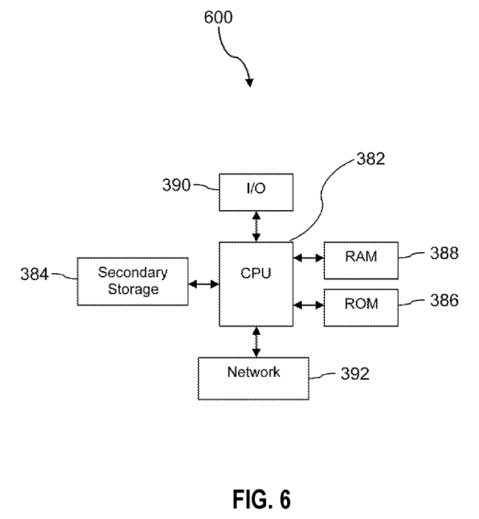

Turning now to FIG. 4, shown is a method 400 for automated multi-level model training and selection in a bidding environment according to an embodiment of the present disclosure. Method 400 may be performed by the configuration application 150, the model trainer application 153, the model evaluator application 156, and/or the metadata application 159 executing at the multi-level model selection system 103. In embodiments, the method 400 may be implemented using a computer system with components as shown in FIG. 6. As illustrated, method 400 of FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At step 403, method 400 comprises receiving, by the configuration application 150 executing at the multi-level model selection system 103, configuration data 128 from the configuration data store 109. In an embodiment, the configuration data 128 comprises information identifying targeted data delivery programs and associated targeting parameters. The configuration data 128 may include line item identifiers, source identifiers, country identifiers, optimization type identifiers, and/or other targeting parameters for active campaigns as stored in the line item data 142.

At step 406, method 400 comprises generating, by the configuration application 150, model training requirements 207 based on the configuration data 128. In an embodiment, the model training requirements 207 comprise specifications indicating which hierarchical levels of data models 205 to train and data volume requirements for each hierarchical level. The model training requirements 207 may specify global, country, and source hierarchical levels along with minimum data thresholds for training specialized models.

At step 409, method 400 comprises training, by the model trainer application 153 executing at the multi-level model selection system 103, data models 205 in parallel based on the model training requirements 207 and training data 140 received from one or more external data systems 106. In an embodiment, the data models 205 comprise at least a global model 250, a country model 253, and a source model 256.

At step 412, method 400 comprises evaluating, by the model evaluator application 156 executing at the multi-level model selection system 103, candidate models from among the trained data models 205 stored in the trained model repository 122 based on feedback data 144 received from the bidder system 112 to generate performance metrics 131 for the candidate models. At step 415, method 400 comprises selecting, by the model evaluator application 156, an optimal data model 205 for each line item based on the performance metrics 131. The selection may comprise identifying the candidate data model 205 with the highest score for each line item, and the model evaluator application 156 may update the model selection mappings 134 stored in the data store 125 to indicate which optimal model has been selected.

At step 418, method 400 comprises sending, by the model metadata application 159 executing at the multi-level model selection system 103, model metadata 137 describing the optimal data model 205 to the bidder system 112 to enable the bidder application 176 of the bidder system 112 to automatically identify and load the optimal data model 205 with relevant incoming bid requests.

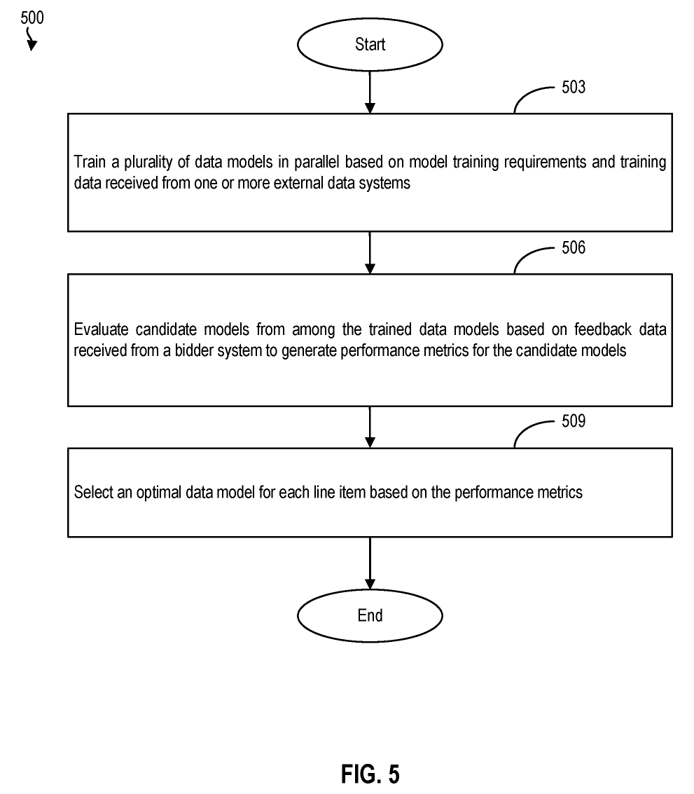

Turning now to FIG. 5, shown is a method 500 for automated multi-level model training and selection according to an embodiment of the present disclosure. Method 500 may be performed by instructions stored on a non-transitory computer-readable medium that, when executed by one or more processors of the multi-level model selection system 103, cause the multi-level model selection system 103 to perform the operations described herein. In embodiments, the method 500 may be implemented using a computer system with components as shown in FIG. 6. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At step 503, method 500 comprises training a plurality of data models 205 in parallel based on model training requirements 207 and training data 140 received from one or more external data systems 106. At step 506, method 500 comprises evaluating candidate models from among the trained data models 205 stored in the trained model repository 122 based on feedback data 144 received from the bidder system 112 to generate performance metrics 131 for the candidate models. At step 509, method 500 comprises selecting an optimal data model 205 for each line item based on the performance metrics 131. The selection process performed by the model evaluator application 156 may involve comparing performance metrics 131 across multiple candidate data models 205 and identifying the highest-performing data model 205 for each individual line item, and the model evaluator application 156 may update the model selection mappings 134 stored in the data store 125.

FIG. 6 illustrates a computer system 600 suitable for implementing one or more embodiments disclosed herein. In an embodiment, multi-level model selection system 103, trained model repositories 122, external data systems 106, configuration data store 109, and/or bidder system 112, may each be implemented as the computer system 600. The computer system 600 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 600, at least one of the CPU 382, the RAM 388, and the ROM 386 are changed, transforming the computer system 600 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 600 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 600 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 600 to provide the functionality of a number of servers that is not directly bound to the number of computers in the computer system 600. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 600, at least portions of the contents of the computer program product to the secondary storage 384, to the ROM 386, to the RAM 388, and/or to other non-volatile memory and volatile memory of the computer system 600. The processor 382 may process the executable instructions and/or data structures in part by directly accessing the computer program product, for example by reading from a CD-ROM disk inserted into a disk drive peripheral of the computer system 600. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 600.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 600 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A multi-level model selection system for automated multi-level model training and selection in a bidding environment:
one or more memories;
one or more processors coupled to the one or more memories;
a configuration application, stored at the one or more memories, which when executed by the one or more processors, causes the one or more processors to be configured to:
receive configuration data from a configuration data store; and
generate model training requirements based on the configuration data, wherein the configuration data comprises at least one of line item identifiers, optimization type identifiers, country identifiers, or data delivery source identifiers;
a model trainer application, stored at the one or more memories, which when
executed by the one or more processors, causes the one or more processors to be
configured to:
receive the model training requirements from the configuration application and training data from an external data system; and
train a plurality of data models in parallel based on the model training requirements and the training data, wherein the plurality of data models comprises at least a global model, a country model, and a source model;
a model evaluator application, stored at the one or more memories, which when executed by the one or more processors, causes the one or more processors to be configured to:
access the trained data models and feedback data received from a bidder system to evaluate candidate models from among the trained data models based on the feedback data and generate performance metrics for the candidate models; and
select an optimal data model for each line item based on the performance metrics; and
a model metadata application, stored at the one or more memories, which when executed by the one or more processors, causes the one or more processors to be configured to send model metadata describing the optimal data model to the bidder system to enable the bidder system to automatically identify and load the optimal data model with relevant incoming bid requests.

2. The multi-level model selection system of claim 1, wherein the line item identifiers correspond to targeted data delivery programs with specific optimization goals, wherein the optimization type identifiers indicate at least one of clicks, video completions, or pixel page landings, wherein the country identifiers indicate geographic locations for data delivery, and wherein the data source identifiers correspond to entities purchasing data content inventory through the bidder system.

3. The multi-level model selection system of claim 1, wherein the model training requirements comprise specifications indicating which hierarchical levels of data models to train, wherein the specifications include at least one of a global level, a country level, or a source level, and training data volume requirements for each hierarchical level.

4. The multi-level model selection system of claim 1, wherein the training data comprises bid stream data and event data collected from the external data system over a predetermined time period, wherein the bid stream data comprises bid request characteristics and bid response information, and wherein the event data comprises outcome indicators for delivered targeted content delivery.

5. The multi-level model selection system of claim 1, wherein the plurality of data models further comprises a line-item model trained on data filtered by line item identifier, wherein the line-item model is dedicated to a single line item and not shared across multiple line items, wherein the global model is trained on aggregated data across all line items, the country model is trained on data filtered by a country identifier, and the source model is trained on data filtered by a data source identifier, wherein each of the global model, the country model, and the source model predicts a likelihood of an optimization event for incoming bid requests.

6. The multi-level model selection system of claim 1, wherein the feedback data comprises recent bid request data and corresponding outcome data collected from the bidder system indicating actual performance of previously deployed data models in real-time bidding scenarios.

7. The multi-level model selection system of claim 1, wherein the performance metrics comprise scores calculated for each of the candidate models by applying each candidate model to the feedback data and measuring accuracy of positive event predictions, wherein the optimal data model is selected based on a highest score among the candidate models for each line item.

8. A method for automated multi-level model training and selection in a bidding environment, the method comprising:
receiving, by a configuration application executing at a computer system, configuration data from a configuration data store, wherein the configuration data comprises information identifying targeted data delivery programs and associated targeting parameters;
generating, by the configuration application, model training requirements based on the configuration data, wherein the model training requirements comprise specifications indicating which hierarchical levels of data models to train and data volume requirements for each hierarchical level;
training, by a model trainer application executing at the computer system, a plurality of data models in parallel based on the model training requirements and training data received from one or more external data systems, wherein the plurality of data models comprises at least a global model, a country model, and a source model;
evaluating, by a model evaluator application executing at the computer system, candidate models from among the trained data models based on feedback data received from a bidder system to generate performance metrics for the candidate models;
selecting, by the model evaluator application, an optimal data model for each line item based on the performance metrics; and
sending, by a model metadata application executing at the computer system, model metadata describing the optimal data model to the bidder system to enable the bidder system to automatically identify and load the optimal data model with relevant incoming bid requests.

9. The method of claim 8, wherein each line item corresponds to an individual targeted data delivery program with a specific optimization goal and targeting criteria, and wherein the line item is associated with at least one of a source identifier, a country identifier, or an optimization type identifier.

10. The method of claim 8, wherein the training data comprises bid stream data and event data collected from the one or more external data systems over a predetermined time period.

11. The method of claim 8, wherein the global model is trained on aggregated data across all line items, wherein the country model is trained on data filtered by the country identifier, and wherein the source model is trained on data filtered by the data source identifier.

12. The method of claim 8, wherein the feedback data comprises recent bid request data and corresponding outcome data collected from the bidder system indicating actual performance of previously deployed data models.

13. The method of claim 8, wherein the performance metrics comprise scores calculated for each of the candidate models, and wherein selecting the optimal data model comprises identifying a candidate model with a highest score for each line item.

14. A non-transitory computer-readable medium storing instructions that, when executed by one or more processors of a computer system, cause the computer system to:
train a plurality of data models in parallel based on model training requirements and training data received from one or more external data systems;
evaluate candidate models from among the trained data models based on feedback data received from a bidder system to generate performance metrics for the candidate models; and
select an optimal data model for each line item based on the performance metrics.

15. The non-transitory computer-readable medium of claim 14, wherein each line item corresponds to an individual targeted data delivery program with a specific optimization goal and targeting criteria.

16. The non-transitory computer-readable medium of claim 14, wherein the instructions further cause the computer system to receive configuration data from a configuration data store and generate the model training requirements based on the configuration data.

17. The non-transitory computer-readable medium of claim 14, wherein the plurality of data models comprises at least a global model, a country model, and a source model, wherein the global model is trained on aggregated data across all line items, wherein the country model is trained on data filtered by a country identifier, and wherein the source model is trained on data filtered by a data source identifier.

18. The non-transitory computer-readable medium of claim 14, wherein the performance metrics comprise scores calculated for each of the candidate models by applying each candidate model to the feedback data.

19. The non-transitory computer-readable medium of claim 14, wherein the instructions further cause the computer system to send model metadata describing the optimal data model to the bidder system to enable the bidder system to automatically identify and load the optimal data model with relevant incoming bid requests.

20. The non-transitory computer-readable medium of claim 14, wherein the training data comprises bid stream data and event data collected from the one or more external data systems over a predetermined time period.
